(19) United States
(12) Patent Application Publication
(10) Pub. No.: US 2024/0213632 A1
(43) Pub. Date: Jun. 27, 2024

(54) CELL LAMINATE

(71) Applicant: HONDA MOTOR CO., LTD., Tokyo (JP)

(72) Inventors: Hideki SAKAMOTO, Saitama (JP); Harumi TAKEDOMI, Saitama (JP); Soichi MORII, Saitama (JP)

(73) Assignee: HONDA MOTOR CO., LTD., Tokyo (JP)

(21) Appl. No.: 18/545,387

(22) Filed: Dec. 19, 2023

(30) Foreign Application Priority Data
Dec. 21, 2022 (JP) 2022-204407

(51) Int. Cl. H01M 50/557; H01M 50/105; H01M 50/178; H01M 50/211; H01M 50/509; H01M 50/516; H01M 50/548

(52) U.S. Cl. CPC H01M 50/557; H01M 50/105; H01M 50/178; H01M 50/211; H01M 50/509; H01M 50/516; H01M 50/548; H01M 2220/20

(57) ABSTRACT

A cell laminate includes: a plurality of laminated cells that are laminated, wherein the plurality of laminated cells include a plurality of first laminated cells and a plurality of second laminated cells, each of first electrode tab leads of the plurality of first laminated cells and second electrode tab leads of the plurality of second laminated cells has a bent portion, and wherein a bent portion of a second electrode tab lead of a second laminated cell closest to the plurality of first laminated cells extends to overlap a bent portion of a first electrode tab lead of a first laminated cell farthest from the plurality of second laminated cells among the plurality of first laminated cells, and each of the bent portions of the plurality of first electrode tab leads overlaps and is directly joined to at least one bent portion of the plurality of second electrode tab leads.

### CROSS-REFERENCE TO RELATED APPLICATIONS

This application is based on and claims priority under 35 USC 119 from Japanese Patent Application No. 2022-204407 filed on Dec. 21, 2022, the entire content of which is incorporated herein by reference.

### TECHNICAL FIELD

The present invention relates to a cell laminate including a plurality of laminated cells that are laminated.

### BACKGROUND ART

In recent years, researches and developments have been conducted on a secondary battery that contributes to an increase in energy efficiency in order to allow more users to access affordable, reliable, sustainable, and advanced energy.

A laminated cell is known as a secondary battery. For example, JP2019-145476A discloses a laminated battery module in which a plurality of laminated battery cells are laminated and electrically connected. In JP2019-145476A, the laminated battery cells are electrically connected directly without interposition of a connection member such as a bus bar. Specifically, a positive electrode terminal and a negative electrode terminal of each laminated battery cell are bent and are each welded to an opposite electrode terminal of an adjacent laminated battery cell in a state of overlapping the opposite electrode terminal.

### SUMMARY OF INVENTION

When a plurality of laminated cells are connected, the plurality of laminated battery cells are connected in series in JP2019-145476A, and parallel connection and series connection may be used in combination in some cases. When the parallel connection and the series connection are used in combination, a bus bar is generally used for joining a positive electrode terminal and a negative electrode terminal.

However, when the bus bar is provided, a space for the bus bar is required, and a total weight increases.

In addition, a method for directly joining the positive electrode terminal and the negative electrode terminal when the parallel connection and the series connection are used in combination is not disclosed in JP2019-145476A, and there is room for further study.

The present invention provides a cell laminate in which a plurality of first laminated cells connected in parallel and a plurality of second laminated cells connected in parallel are connected in series without interposition of a bus bar.

According to the present invention, a plurality of first laminated cells connected in parallel and a plurality of second laminated cells connected in parallel can be connected in series without interposition of a bus bar.

### BRIEF DESCRIPTION OF DRAWINGS

FIG. 1 is a schematic plan view of a cell laminate 1 according to an embodiment of the present invention, which schematically shows an electrical flow path of the cell laminate 1.

FIG. 2 is a perspective view of a laminated cell 2.

FIG. 3 is an enlarged view of a portion X in FIG. 1, which shows connection between positive electrode tab leads 21 and negative electrode tab leads 22 of four adjacent laminated cells A1, A2, B1, and B2.

FIG. 4 shows a manufacturing method of the cell laminate 1.

FIG. 5 shows connection between positive electrode tab leads 21 and negative electrode tab leads 22 of six adjacent laminated cells A1, A2, A3, B1, B2, and B3.

FIG. 6 shows the connection between the positive electrode tab leads 21 and the negative electrode tab leads 22 of four adjacent laminated cells A1, A2, B1, and B2 when the positive electrode tab leads 21 are longer than the negative electrode tab leads 22.

### DESCRIPTION OF EMBODIMENTS

Hereinafter, a cell laminate according to an embodiment of the present invention will be described with reference to the accompanying drawings.

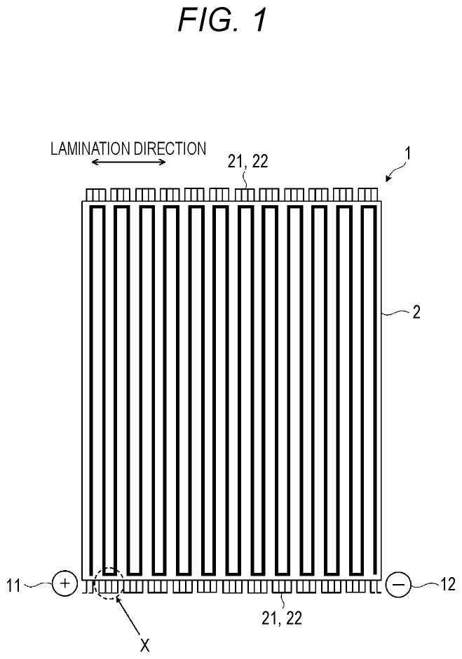

FIG. 1 is a schematic plan view of a cell laminate 1 according to the embodiment of the present invention. The cell laminate 1 includes a plurality of laminated cells 2 laminated in a horizontal direction (a left-right direction in FIG. 1). Although not shown, the cell laminate 1 is accommodated in a battery case and is disposed, for example, under a floor of a vehicle (under a floor panel).

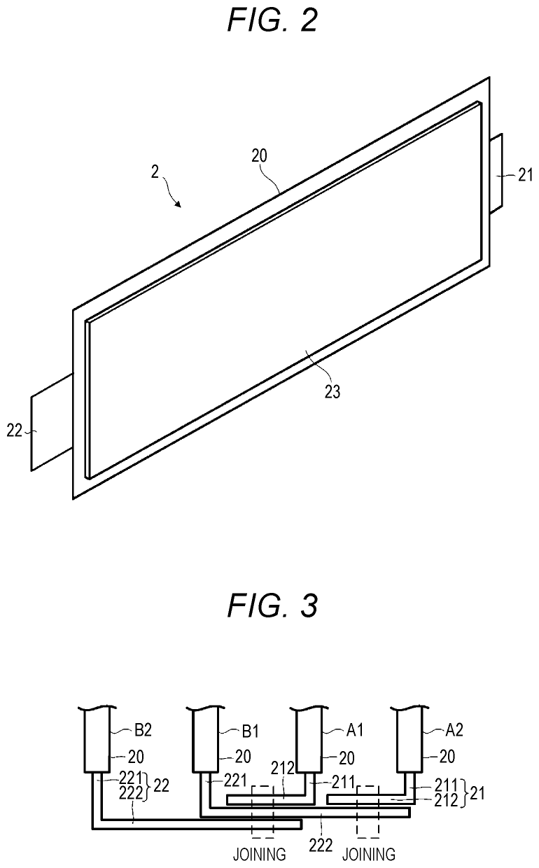

FIG. 2 is a perspective view of the laminated cell 2. The laminated cell 2 is, for example, a solid-state battery. The laminated cell 2 formed of the solid-state battery includes a positive electrode to which a positive electrode tab lead 21 is connected, a negative electrode to which a negative electrode tab lead 22 is connected, a solid electrolyte disposed between the positive electrode and the negative electrode, and a laminate film 23 configured to accommodate the positive electrode, the negative electrode, and the solid electrolyte. The laminated cell 2 performs charging and discharging by transferring and receiving lithium ions through the solid electrolyte between the positive electrode and the negative electrode. A sealing portion 20 is further provided on a peripheral edge of the laminated cell 2.

The positive electrode tab lead 21 extends from the sealing portion 20 at one end of the laminated cell 2 in a longitudinal direction. The negative electrode tab lead 22 extends from the sealing portion 20 at the other end of the laminated cell 2 in the longitudinal direction. In the present embodiment, the negative electrode tab lead 22 of each laminated cell 2 is longer than the positive electrode tab lead 21. Here, in the present embodiment, the positive electrode tab lead 21, which is a short tab lead among the positive electrode tab lead 21 and the negative electrode tab lead 22, corresponds to a “first electrode tab lead” in the present invention, and the negative electrode tab lead 22, which is a long tab lead, corresponds to a “second electrode tab lead” in the present invention.

The positive electrode including the positive electrode tab lead 21 is formed from, for example, aluminum as a material. The negative electrode including the negative electrode tab lead 22 is formed from, for example, copper as a material.

The solid electrolyte in the solid-state battery is not particularly limited as long as the solid electrolyte has lithium ion conductivity and insulating properties, and a material generally used for all solid-state lithium-ion batteries can be used. Examples thereof include: inorganic solid electrolytes such as sulfide solid electrolyte materials, oxide solid electrolyte materials, and lithium-containing salts; polymer solid electrolytes such as polyethylene oxide; and gel solid electrolytes containing a lithium-containing salt or ionic liquid having lithium ion conductivity. A form of the solid electrolyte material is not particularly limited, and, for example, the solid electrolyte material can be in a form of particles.

In the present embodiment, the plurality of laminated cells 2 constituting the cell laminate 1 all have the same configuration and the same dimension. That is, only one type of laminated cell is used.

Referring back to FIG. 1, the plurality of laminated cells 2 are electrically connected in series from an electrical flow path start end 11 (a positive electrode) to an electrical flow path terminal end 12 (a negative electrode) of the cell laminate 1. The electrical flow path start end 11 and the electrical flow path terminal end 12 are connected to, for example, a junction box in which various wiring components are mounted or another cell laminate via a conductive connection member (for example, a bus bar).

FIG. 3 shows connection between the positive electrode tab leads 21 and the negative electrode tab leads 22 of four adjacent laminated cells 2 in the cell laminate 1 and shows connection of a portion X in FIG. 1 as an example. Connection of tab leads other than those in the portion X is similarly performed. Hereinafter, for convenience of description, the four adjacent laminated cells 2 will be distinguished from one another and described with different reference numerals (A1, A2, B1, and B2) attached thereto. However, each of the laminated cells A1, A2, B1, and B2 is identical to the configuration of the laminated cell 2 described above.

Among the four adjacent laminated cells A1, A2, B1, and B2, the laminated cell A1 and the laminated cell A2 are connected in parallel whereas the laminated cell B1 and the laminated cell B2 are connected in parallel. The laminated cells A1 and A2 connected in parallel and the laminated cells B1 and B2 connected in parallel are electrically connected in series.

The positive electrode tab lead 21 of each of the laminated cells A1 and A2 has an extension portion 211 extending from the sealing portion 20 in a direction orthogonal to a lamination direction (that is, a longitudinal direction of the laminated cells A1 and A2), and a bent portion 212 bent in the lamination direction. The bent portion 212 is formed by bending the positive electrode tab lead 21 by 900 toward the negative electrode tab leads 22 and 22 of the laminated cells B1 and B2. A length of the positive electrode tab lead 21 is defined by a sum of a length of the extension portion 211 and a length of the bent portion 212.

Similarly, the negative electrode tab lead 22 of each of the laminated cells B1 and B2 has an extension portion 221 extending from the sealing portion 20 in the direction orthogonal to the lamination direction and a bent portion 222 bent in the lamination direction. The bent portion 222 is formed by bending the negative electrode tab lead 22 by 90° toward the positive electrode tab leads 21 and 21 of the laminated cells A1 and A2. A length of the negative electrode tab lead 22 is defined by a sum of a length of the extension portion 221 and a length of the bent portion 222.

The bent portion 222 of the negative electrode tab lead 22 of the laminated cell B1 closest to the laminated cells A1 and A2 among the laminated cells B1 and B2 extends to overlap the bent portion 212 of the positive electrode tab lead 21 of the laminated cell A2 farthest from the laminated cells B1 and B2 among the laminated cells A1 and A2. As described above, since the negative electrode tab lead 22 of the laminated cell 2 is longer than the positive electrode tab lead 21, the bent portion 222 of the laminated cell B1 can be formed to overlap the bent portion 212 of the laminated cell A2 beyond the bent portion 212 of the laminated cell A1.

The bent portions 212 and 212 of the positive electrode tab leads 21 and 21 of the laminated cells A1 and A2 overlap at least one bent portion 222 of the negative electrode tab leads 22 and 22 of the laminated cells B1 and B2 and are directly joined thereto. Here. “directly joined” means that the positive electrode tab lead 21 and the negative electrode tab lead 22 are electrically connected without interposition of a conductive connection member such as a bus bar. Specifically, the bent portion 212 of the positive electrode tab lead 21 of the laminated cell A2 overlaps the bent portion 222 of the negative electrode tab lead 22 of the laminated cell B1 and is joined thereto by, for example, laser welding. The bent portion 212 of the positive electrode tab lead 21 of the laminated cell A1 overlaps the bent portions 222 and 222 of the negative electrode tab leads 22 and 22 of the laminated cells B1 and B2 and is joined thereto by, for example, laser welding.

According to the connection method of the positive electrode tab lead 21 and the negative electrode tab lead 22 described above, the laminated cells A1 and A2 connected in parallel and the laminated cells B1 and B2 connected in parallel can be connected in series without interposition of a conductive connection member. Accordingly, as compared with a case where a conductive connection member is interposed therebetween, a dimension of the cell laminate 1 is reduced in the direction orthogonal to the lamination direction, and a weight of the cell laminate 1 is reduced. Thus, an energy density of the cell laminate 1 is improved.

Further, as described above, the plurality of laminated cells 2 that are laminated all have the same configuration, and thus only one type of laminated cell is to be prepared when the positive electrode tab leads 21 and the negative electrode tab leads 22 of the four adjacent laminated cells A1, A2, B1, and B2 are connected using parallel connection and series connection in combination. Therefore, for example, lengths of the positive electrode tab leads of the laminated cells A1 and A2 are not required to be different from each other (that is, prepare two types of laminated cells) whereas lengths of the negative electrode tab leads of the laminated cells B1 and B2 are not required to be different from each other (that is, prepare two types of laminated cells), and thus assembly of the cell laminate 1 is improved.

In the present embodiment, the bent portions 212 and 212 of the positive electrode tab leads 21 and 21 of the laminated cells A1 and A2 do not overlap each other. With this configuration, it is possible to reduce the dimension of the cell laminate 1 in the direction orthogonal to the lamination direction, as compared with a case where the bent portions 212 and 212 of the laminated cells A1 and A2 overlap each other.

The bent portions 222 and 222 of the laminated cells B1 and B2 extend to overlap the bent portion 212 of the positive electrode tab lead 21 of the laminated cell A1 closest to the laminated cells B1 and B2 among the laminated cells A1 and A2. The bent portions 222 and 222 of the laminated cells B1 and B2 overlap the bent portion 212 of the laminated cell A1 closest to the laminated cells B1 and B2 and are directly joined thereto. When the bent portion 222 of the laminated cell B2 does not overlap the bent portion 212 of the laminated cell A1, for example, it is necessary to join the bent portion 222 of the laminated cell B2 and the bent portion 222 of the laminated cell B1. However, according to the above-described configuration, since the bent portions 222 and 222 of the laminated cells B1 and B2 overlap the bent portion 212 of the laminated cell A1 and are directly joined thereto, it is not necessary to join the negative electrode tab leads 22 and 22 of the laminated cells B1 and B2. Thus, joining time can be shortened.

The number of the negative electrode tab leads 22 of the laminated cells B1 and B2 overlapping the bent portion 212 of the laminated cell A1 closest to the laminated cells B1 and B2 is larger than the number of the negative electrode tab leads 22 of the laminated cells B1 and B2 overlapping the bent portion 212 of the laminated cell A2 farthest from the laminated cells B1 and B2. In the present embodiment, the number of the negative electrode tab leads 22 of the laminated cells B1 and B2 overlapping the bent portion 212 of the laminated cell A1 is two, and the number of the negative electrode tab leads 22 of the laminated cells B1 and B2 overlapping the bent portion 212 of the laminated cell A2 is one.

When a current flows through the laminated cells A1. A2, B1, and B2, a passing current is concentrated in a region between the laminated cells A1 and A2 and the laminated cells B1 and B2. In the present embodiment, in the region between the laminated cells A1 and A2 and the laminated cells B1 and B2, the number of overlapping bent portions 212 and 222 is large, and thus a total cross-sectional area of the bent portions 212, 222, and 222 in this region is large. Thus, loss in this region can be reduced.

As described above, the negative electrode tab lead 22 is formed from copper, and the positive electrode tab lead 21 is formed from aluminum. When a thickness of a tab lead formed from copper is compared with a thickness of a tab lead formed from aluminum, the tab lead formed from copper is thinner. That is, in the present embodiment, the negative electrode tab lead 22 is thinner than the positive electrode tab lead 21. Therefore, since the negative electrode tab lead 22 is thin, the dimension of the cell laminate 1 can be further reduced in the direction orthogonal to the lamination direction.

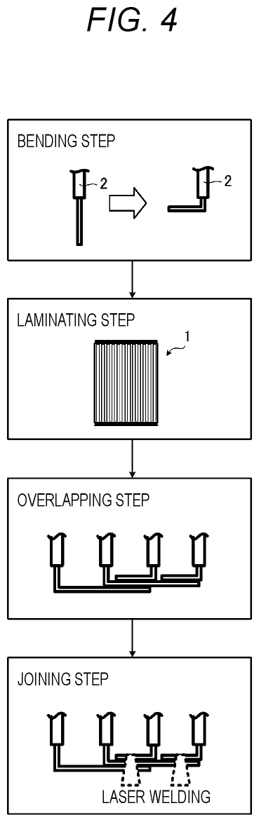

Next, a manufacturing method of the cell laminate 1 in which the plurality of laminated cells 2 are connected using parallel connection and series connection in combination will be described with reference to FIG. 4.

FIG. 4 shows the manufacturing method of the cell laminate 1. The manufacturing method of the cell laminate 1 includes a bending step, a laminating step, an overlapping step, and a joining step. In the bending step, the positive electrode tab lead 21 and the negative electrode tab lead 22 of each laminated cell 2 are bent to form the extension portions 211 and 221 and the bent portions 212 and 222. After the bending step, in the laminating step, the plurality of laminated cells 2 are laminated in the horizontal direction. After the laminating step, in the overlapping step, the bent portion 212 of the positive electrode tab lead 21 and the bent portion 222 of the negative electrode tab lead 22 of four adjacent laminated cells 2 are overlapped according to the above-described configuration. After the overlapping step, in the joining step, for example, laser welding is performed at a position where the bent portion 212 of the positive electrode tab lead 21 overlaps the bent portion 222 of the negative electrode tab lead 22 to join the bent portion 212 and the bent portion 222. As described above, the cell laminate 1 is manufactured. An order of the bending step and the laminating step may be reversed.

### <<First Modification>>

In the above-described embodiment, the two adjacent laminated cells A1 and A2 (and B1 and B2) are connected in parallel, and three or more adjacent laminated cells 2 may be connected in parallel. In a first modification, a case where three adjacent laminated cells 2 are connected in parallel will be described.

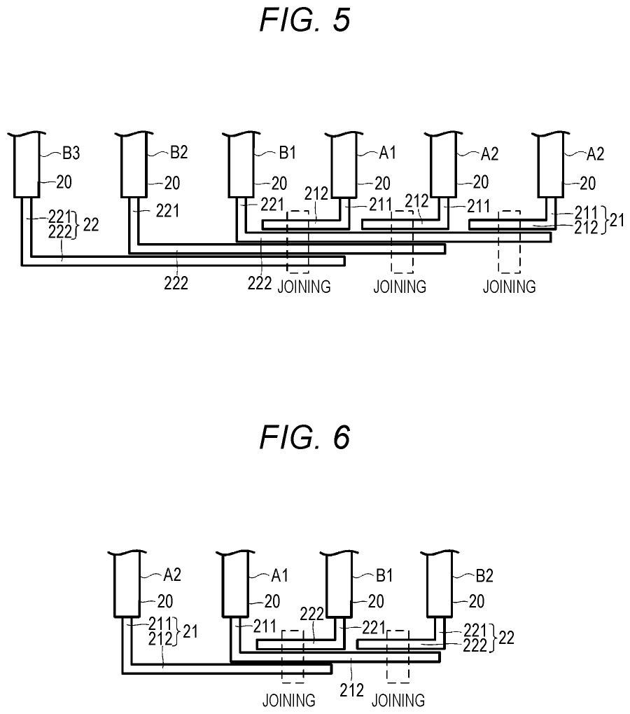

FIG. 5 shows connection between positive electrode tab leads 21 and negative electrode tab leads 22 of six adjacent laminated cells A1, A2, A3, B1, B2, and B3. Similarly to the above-described embodiment, the bent portion 222 of the negative electrode tab lead 22 of the laminated cell B1 closest to the laminated cells A1, A2, and A3 among the laminated cells B1, B2, and B3 extends to overlap the bent portion 212 of the positive electrode tab lead 21 of the laminated cell A3 farthest from the laminated cells B1, B2, and B3 among the laminated cells A1, A2, and A3. The bent portions 212, 212, and 212 of the positive electrode tab leads 21, 21, and 21 of the laminated cells A1, A2, and A3 overlap at least one bent portion 222 of the negative electrode tab leads 22, 22, and 22 of the laminated cells B1, B2, and B3 and are directly joined thereto.

In this way, even when three adjacent laminated cells 2 are connected in parallel, the laminated cells A1, A2, and A3 connected in parallel and the laminated cells B1, B2, and B3 connected in parallel can be connected in series without interposition of a conductive connection member.

### <<Second Modification>>

In the above-described embodiment and the first modification, the negative electrode tab lead 22 of each laminated cell 2 is longer than the positive electrode tab lead 21. However, the positive electrode tab lead 21 may be longer than the negative electrode tab lead 22.

FIG. 6 shows the connection between the positive electrode tab leads 21 and the negative electrode tab leads 22 of four adjacent laminated cells A1, A2, B1, and B2 when the positive electrode tab leads 21 are longer than the negative electrode tab leads 22. The bent portion 212 of the positive electrode tab lead 21 of the laminated cell A1 closest to the laminated cells B1 and B2 among the laminated cells A1 and A2 extends to overlap the bent portion 222 of the negative electrode tab lead 22 of the laminated cell B2 farthest from the laminated cells A1 and A2 among the laminated cells B1 and B2. The bent portions 222 and 222 of the negative electrode tab leads 22 and 22 of the laminated cells B1 and B2 overlap at least one bent portion 212 of the positive electrode tab leads 21 and 21 of the laminated cells A1 and A2 and are directly joined thereto. Here, in the second modification, the negative electrode tab lead 22, which is a short tab lead among the positive electrode tab lead 21 and the negative electrode tab lead 22, corresponds to the “first electrode tab lead” in the present invention, and the positive electrode tab lead 21, which is a long tab lead, corresponds to the “second electrode tab lead” in the present invention.

Aluminum, which is the positive electrode material, has a lower density than copper, which is the negative electrode material. Thus, it is possible to reduce the weight of the cell laminate 1 by lengthening the low-density positive electrode tab lead 21 and shortening the high-density negative electrode tab lead 22. In addition, since aluminum is less expensive than copper, a manufacturing cost of the cell laminate 1 can be reduced by forming the long positive electrode tab lead 21 from aluminum at a low cost and forming the short negative electrode tab lead 22 from copper.

Although an embodiment of the present invention has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, respective constituent elements in the above embodiment may be freely combined without departing from the gist of the invention.

In the present specification, at least the following matters are described. In the parentheses, the corresponding constituent elements and the like in the above embodiment are shown as an example, but the present invention is not limited thereto.
(1) A cell laminate (the cell laminate 1) including:
a plurality of laminated cells (the plurality of laminated cells 2) that are laminated, in which
each of the laminated cells includes a sealing portion (the sealing portion 20) on a peripheral edge and is configured such that a first electrode tab lead (the positive electrode tab lead 21 and the negative electrode tab lead 22) and a second electrode tab lead (the negative electrode tab lead 22 and the positive electrode tab lead 21) extend from the sealing portion, the first electrode tab lead being one of a positive electrode or a negative electrode and the second electrode tab lead being the other electrode,
the plurality of laminated cells include a plurality of first laminated cells (the laminated cells A1 and A2) and a plurality of second laminated cells (the laminated cells B1 and B2), the plurality of first laminated cells being adjacent to each other in a lamination direction and electrically connected in parallel, the plurality of second laminated cells being adjacent to each other in the lamination direction and electrically connected in parallel,
the plurality of first laminated cells and the plurality of second laminated cells are electrically connected in series,
first electrode tab leads of the plurality of first laminated cells have the same length,
second electrode tab leads of the plurality of second laminated cells have the same length,
each of the second electrode tab leads of the plurality of second laminated cells is longer than each of the first electrode tab leads of the plurality of first laminated cells,
each of the first electrode tab leads of the plurality of first laminated cells and the second electrode tab leads of the plurality of second laminated cells has:
an extension portion (the extension portions 211 and 221) extending from the sealing portion in a direction orthogonal to the lamination direction; and
a bent portion (the bent portions 212 and 222) bent in the lamination direction, in which
a bent portion of a second electrode tab lead of a second laminated cell closest to the plurality of first laminated cells among the plurality of second laminated cells extends to overlap a bent portion of a first electrode tab lead of a first laminated cell farthest from the plurality of second laminated cells among the plurality of first laminated cells, and
each of the bent portions of the plurality of first electrode tab leads of the plurality of first laminated cells overlaps and is directly joined to at least one bent portion of the plurality of second electrode tab leads of the plurality of second laminated cells.

According to (1), the first laminated cells connected in parallel and the second laminated cells connected in parallel can be connected in series without interposition of a conductive connection member. As compared with a case where a conductive connection member is interposed for connection between the first electrode tab lead and the second electrode tab lead, a dimension of the cell laminate is reduced in the direction orthogonal to the lamination direction, and a weight of the cell laminate is reduced. Thus, an energy density of the cell laminate is improved.
(2) The cell laminate according to (1), in which
the bent portions of the plurality of first electrode tab leads of the plurality of first laminated cells do not overlap one another.

According to (2), it is possible to reduce the dimension of the cell laminate in the direction orthogonal to the lamination direction.
(3) The cell laminate according to (1) or (2), in which
the bent portions of the plurality of second laminated cells
extend to overlap a bent portion of a first electrode tab lead of a first laminated cell closest to the plurality of second laminated cells among the plurality of first laminated cells, and
overlap and are directly joined to the bent portion of the first laminated cell closest to the plurality of second laminated cells.

According to (3), since the bent portions of the plurality of second laminated cells overlap the bent portion of the first laminated cell closest to the second laminated cells and are directly joined thereto, it is not necessary to directly join the second electrode tab leads of the plurality of second laminated cells. Thus, joining time can be shortened.
(4) The cell laminate according to (3), in which
the number of the second electrode tab leads of the plurality of second laminated cells that overlap the bent portion of the first laminated cell closest to the plurality of second laminated cells is larger than the number of second electrode tab leads of the plurality of second laminated cells that overlap the bent portion of the first laminated cell farthest from the plurality of second laminated cells.

When a current flows through the plurality of first laminated cells and the plurality of second laminated cells, a passing current is concentrated in a region between the first laminated cells and the second laminated cells. According to (4), since the number of overlapping bent portions in this region is large, a total cross-sectional area of the bent portions in this region is large. Thus, loss in this region can be reduced.
(5) The cell laminate according to any one of (1) to (4), in which
the plurality of first electrode tab leads of the plurality of first laminated cells and the plurality of second electrode tab leads of the plurality of second laminated cells are directly joined at the bent portions by welding.

According to (5), the plurality of first electrode tab leads and the plurality of second electrode tab leads can be directly joined by welding.
(6) The cell laminate according to any one of (1) to (5), in which
the second electrode tab lead is thinner than the first electrode tab lead.

According to (6), since the second electrode tab lead longer than the first electrode tab lead is thin, the dimension of the cell laminate can be further reduced in the direction orthogonal to the lamination direction.
(7) The cell laminate according to any one of (1) to (5), in which
the second electrode tab lead is formed from a material having a lower density than the first electrode tab lead.

According to (7), since the second electrode tab lead longer than the first electrode tab lead is formed from a material having a low density, the weight of the cell laminate can be reduced.

What is claimed is:

1. A cell laminate comprising:
a plurality of laminated cells that are laminated, wherein
each of the laminated cells includes a sealing portion on a peripheral edge and is configured such that a first electrode tab lead and a second electrode tab lead extend from the sealing portion, the first electrode tab lead being one of a positive electrode or a negative electrode and the second electrode tab lead being the other electrode,
the plurality of laminated cells include a plurality of first laminated cells and a plurality of second laminated cells, the plurality of first laminated cells being adjacent to each other in a lamination direction and electrically connected in parallel, the plurality of second laminated cells being adjacent to each other in the lamination direction and electrically connected in parallel,
the plurality of first laminated cells and the plurality of second laminated cells are electrically connected in series,
first electrode tab leads of the plurality of first laminated cells have the same length,
second electrode tab leads of the plurality of second laminated cells have the same length,
each of the second electrode tab leads of the plurality of second laminated cells is longer than each of the first electrode tab leads of the plurality of first laminated cells,
each of the first electrode tab leads of the plurality of first laminated cells and the second electrode tab leads of the plurality of second laminated cells has:
an extension portion extending from the sealing portion in a direction orthogonal to the lamination direction; and
a bent portion bent in the lamination direction, wherein
a bent portion of a second electrode tab lead of a second laminated cell closest to the plurality of first laminated cells among the plurality of second laminated cells extends to overlap a bent portion of a first electrode tab lead of a first laminated cell farthest from the plurality of second laminated cells among the plurality of first laminated cells, and
each of the bent portions of the plurality of first electrode tab leads of the plurality of first laminated cells overlaps and is directly joined to at least one bent portion of the plurality of second electrode tab leads of the plurality of second laminated cells.

2. The cell laminate according to claim 1, wherein
the bent portions of the plurality of first electrode tab leads of the plurality of first laminated cells do not overlap one another.

3. The cell laminate according to claim 1, wherein
the bent portions of the plurality of second laminated cells
extend to overlap a bent portion of a first electrode tab lead of a first laminated cell closest to the plurality of second laminated cells among the plurality of first laminated cells, and
overlap and are directly joined to the bent portion of the first laminated cell closest to the plurality of second laminated cells.

4. The cell laminate according to claim 3, wherein
the number of the second electrode tab leads of the plurality of second laminated cells that overlap the bent portion of the first laminated cell closest to the plurality of second laminated cells is larger than the number of second electrode tab leads of the plurality of second laminated cells that overlap the bent portion of the first laminated cell farthest from the plurality of second laminated cells.

5. The cell laminate according to claim 1, wherein
the plurality of first electrode tab leads of the plurality of first laminated cells and the plurality of second electrode tab leads of the plurality of second laminated cells are directly joined at the bent portions by welding.

6. The cell laminate according to claim 1, wherein
the second electrode tab lead is thinner than the first electrode tab lead.

7. The cell laminate according to claim 1, wherein
the second electrode tab lead is formed from a material having a lower density than the first electrode tab lead.
